(19) United States
(12) Patent Application Publication
(10) Pub. No.: US 2014/0016568 A1
(43) Pub. Date: Jan. 16, 2014

(54) METHOD AND APPARATUS FOR FACILITATING CHANNEL SWITCHING

(71) Applicants: Timo Koskela, Oulu (FI); Anna Pantelidou, Oulu (FI); Samuli Turtinen, Ii (FI); Sami-Jukka Hakola, Kempele (FI)

(72) Inventors: Timo Koskela, Oulu (FI); Anna Pantelidou, Oulu (FI); Samuli Turtinen, Ii (FI); Sami-Jukka Hakola, Kempele (FI)

(73) Assignee: RENESAS MOBILE CORPORATION, Tokyo (JP)

(21) Appl. No.: 13/550,045

(22) Filed: Jul. 16, 2012

(51) Int. Cl. H04W 72/02

(52) U.S. Cl. 370/329

(57) ABSTRACT

A method, apparatus and computer program product are provided to facilitate synchronization of one or more stations with an access point when the stations have awakened from a sleep period. In the context of a method, a channel switch announcement is caused to be provided on a first channel that indicates that an access point is to switch to a second channel. The method also provides for the access point to switch to the second channel and, following switching of the access point to the second channel, the method causes a post-announcement to be provided on the first channel indicating that the access point previously switched to the second channel.

### TECHNOLOGICAL FIELD

An example embodiment of the present invention relates generally to wireless communication technology and, more particularly, to a method, apparatus and computer program product for facilitating switching from a first channel to a second channel.

### BACKGROUND

In addition to cellular networks, an increasing number of other wireless network topologies are being developed and implemented. These other network topologies include, for example, Wi-Fi networks, ad hoc networks and various other local area networks. Regardless of the topology, the wireless networks support communication with a plurality of stations. The stations, either mobile or fixed, supported by these network topologies may communicate with one another in an unlicensed spectrum, such as the license-exempt industrial scientific medical (ISM) radio band. The ISM radio band supports non-cellular systems, such as Wi-Fi systems operating in accordance with the IEEE 802.11 standard, ZigBee systems operating in accordance with the IEEE 802.15 standard, Bluetooth systems and universal serial bus (USB) wireless systems. In this regard, the ISM radio band may include the 2.4 GHz ISM band in which Wi-Fi 802.11g and 802.11n systems operate and the 5 GHz ISM band in which Wi-Fi 802.11n/ac systems operate.

In one wireless communication system, such as a Wi-Fi system, an access point is configured to support communications with a substantial number of stations, such as up to 6,000 stations or more. These stations may include mobile terminals, such as dual mode cellular telephones, sensors, smart meters and the like. The stations may be embodied in a number of different forms and may include, for example, an actuator, a display, a memory device or the like.

In some wireless communications network, the stations may operate on a fairly strict energy budget. For example, the stations may be battery-powered sensors that are configured to transmit and to receive data rarely and, as such, may remain in a low-power operation mode, such as a sleep mode, for relatively long periods of time in order to conserve energy. In an 802.11 network, the basic mode of operation is a distributed coordination function (DCF) mode. In order to support a substantial number of stations operating in a random access mode, such as within an 802.11 network, the access point may utilize various techniques to restrict the contention for the channel that is utilized for communication between the access point and the stations so as to avoid collisions of simultaneous transmissions from different stations across the same channel. One technique to reduce channel contention and to limit collisions on the channel is to group stations and to assign certain parameters to each group that indicate the timing with which each group can access the channel. The information defining the grouping of the stations and the parameters that govern the operation of each station may be provided by an access point to the stations during the association phase or during the broadcast of information via a beacon.

The stations may operate in a low-power mode for a prolonged period of time. As such, techniques to reduce channel contention and collision may be somewhat difficult to implement in that the parameters associated with a particular group may no longer be valid at the time that a station wakes up from a low-power mode of operation and resumes channel access operations. Additionally, since broadcast messages, such as beacons, transmitted by the access point are potentially received by a station relatively infrequently, a station that remains in a low-power mode of operation for an extended period of time may lose synchronization due to, for example, internal clock drift by the access point and the station, and may be unable to estimate the timing of the next beacon transmission. Thus, a station may have to remain awake and consume additional energy for a longer period of time in order to receive a beacon transmission.

In an 802.11 network, the access point buffers the data frames in an instance in which a station is in a low-power mode of operation. The access point may then inform the station regarding the buffered frames by providing a traffic indication map (TIM), which is transmitted in the beacon. Once the station awakes, the station may retrieve the buffered frames from the access point. For example, the station may transmit some buffered uplink data, which serves to implicitly notify the access point that the station is awake such that the access point may, in turn, provide the buffered frames to the station. Alternatively, the station may transmit a power save (PS)-poll message to the access point to indicate to the access point that the station is awake and ready to receive data, such as the buffered frames.

In the IEEE 802.11 ah standard, the USA channelization is defined to have channel widths of one, two, four, eight, and sixteen megahertz. Since a 26 megahertz spectrum is available, the number of potential channels for relatively narrow-band basic service sets (BSSs) is relatively high. In this regard, there may be 26 one megahertz channels and 13 two megahertz channels available. To avoid overlapping BSSs in an 802.11 system, the system may support multiple operating channels on a given frequency band. For example, in the 2.4 GHz band, there may be 14 different channels available with three of the channels configured to be used simultaneously with non-overlapping BSSs. Having a relatively large number of channels is desirable for a system operating in an unlicensed band which is shared between different systems by providing for improved coexistence between other stations and access points, that is, between BSSs, as well as avoiding interference between different systems that operate on the same frequency band, such as a ZigBee system.

One coexistence technique that is provided by the IEEE 802.11 specification relates to channel switching in which an access point selects a different operating channel or potentially a different operating class in an instance of switching from the 2.4 GHz band to the 5 GHz band. At least some use cases of an 802.11 network do not require that the stations have extended sleep periods. As such, the channel switch procedure described by the IEEE 802.11 specification has an announcement mechanism that permits the access point to broadcast the channel switch command or a channel switch indication several times prior to the switch from one channel to another channel so that the stations will be able to follow the access point to the new channel. In instances in which the stations do not sleep for extended periods of time, the stations are likely to receive one or more of the channel switch announcements broadcast by the access point so as to be able to follow the access point to the new channel when the access point subsequently transitions to the new channel.

In a number of instances, the stations are deployed as sensors, smart meters or the like and may be utilized for purposes a metering. In these instances, the access point and the stations may utilize the 1 MHz and 2 MHz channels. Additionally, the stations, such as the sensors and smart meters, may be configured to operate in a low-power mode, such as by sleeping, as much as possible in order to extend the replacement cycle and may correspondingly be configured to operate in an energy efficient manner with respect to radio transmission and reception. By operating in a relatively low-power state and otherwise in an energy efficient manner, the stations operating a 1 MHz or 2 MHz channel that have extended periods of sleep may not be alerted of an impending switch of channels by the access point and may awake from an extended period of sleep and have difficulty synchronizing with the access point and determining the channel via which to communicate with the access point in an energy efficient and timely manner.

### BRIEF SUMMARY

A method, apparatus and computer program product are provided in accordance with one embodiment to facilitate synchronization of one or more stations with an access point when the stations have awakened from a sleep period. By facilitating synchronization between stations operating in a low-power mode and an access point, the stations may operate in an energy efficient manner while still being able to communicate with the access point during periods in which the stations are awake. In this regard, the method, apparatus and computer program product of an example embodiment facilitate the synchronization between an access point and stations operating in a low-power mode even in instances in which the stations are utilizing relatively narrow channels, such as 1 MHz or 2 MHz channels for communication with the access point.

In one embodiment, a method is provided that includes causing a channel switch announcement to be provided on a first channel that indicates that an access point is to switch to a second channel. The method of this embodiment provides, with a processor, for the access point to switch to the second channel. Following switching of the access point to the second channel, the method also causes a post-announcement to be provided on the first channel indicating that the access point previously switched to the second channel.

In another embodiment, an apparatus is provided that includes at least one processor and at least one memory including computer program code with the at least one memory and computer program code configured to, with the at least one processor, cause the apparatus at least to cause a channel switch announcement to be provided on the first channel that indicates that an access point is to switch to a second channel and to provide for the access point to switch to the second channel. The at least one memory and the computer program code are also configured to, with the at least one processor, cause the apparatus of one embodiment to cause a post-announcement to be provided on the first channel following switching of the access point to the second channel with the post-announcement indicating that the access point previously switched to the second channel.

In a further embodiment, a computer program product is provided that includes at least one non-transitory computer-readable storage medium having computer-readable program instructions stored therein with the computer-readable program instructions including program instructions configured to cause a channel switch announcement to be provided on a first channel that indicates that an access point is to switch to a second channel. The computer-readable program instructions of this embodiment also include program instructions configured to provide for the access point to switch to the second channel. The computer-readable program instructions of this embodiment further include program instructions configured to cause a post-announcement to be provided on the first channel following switching of the access point to the second channel. The post-announcement is provided on the first channel indicates that the access point previously switched to the second channel.

In yet another embodiment, an apparatus is provided that includes means for causing a channel switch announcement to be provided on a first channel that indicates that an access points is to switch to a second channel. The apparatus of this embodiment also includes means for providing for the access point to switch to the second channel and means for causing a post-announcement to be provided on the first channel following switching of the access point to the second channel. In this regard, the post-announcement that is provided on a first channel indicates that the access point previously switched to the second channel.

In one embodiment, a method is provided that includes commencing a sleep period while an access point is operating on the first channel. The method of this embodiment also includes awakening from the sleep period and receiving and processing, with a processor, a post-announcement originating at the access point on the first channel indicating that the access point previously switched to the second channel.

In another embodiment, an apparatus is provided that includes at least one processor and at least one processor and at least one memory including computer program code with the at least one memory and the computer program code configured to, with the at least one processor, cause the apparatus at least to commence a sleep period while an access point is operating on the first channel. The at least one memory the computer program code are also configured to, with the at least one processor, cause the apparatus of this embodiment to awake from the sleep period and to receive and process a post-announcement originating with the access point on the first channel indicating that the access point previously switched to a second channel.

In a further embodiment, a computer program product is provided that includes at least one non-transitory computer-readable storage medium having computer-readable program instructions stored therein with the computer-readable program instructions including program instructions configured to commence a sleep period while an access point is operating on the first channel and program instructions configured to awaken from the sleep period. The computer-readable program instructions of this embodiment also include program instructions configured to receive and process a post-announcement originating with the access point on the first channel indicating that the access point previously switched to a second channel.

In yet another embodiment, an apparatus is provided that includes means for commencing a sleep period while an access point is operating on a first channel and then for awakening from a sleep period. The apparatus of this embodiment also includes means for receiving and means for processing a post-announcement originating with the access point on the first channel indicating that the access point previously switched to a second channel.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of a wireless communication system that supports communication between an access point and a plurality of stations;

FIG. 2 is a block diagram of an apparatus that may be embodied by an access point or by a station and that may be specifically configured in accordance with an example embodiment of the present invention;

FIG. 3 illustrates a flow chart of the operations performed by an apparatus embodied by an access point in accordance with an example embodiment of the present invention;

FIG. 4 is a graphical representation of the issuance of a post-announcement by an access point in accordance with an example embodiment of the present invention;

FIG. 5 illustrates a beacon frame including a post-announcement information element in accordance with an example embodiment of the present invention; and

FIG. 6 is a flow chart illustrating the operations performed by an apparatus embodied by a station in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

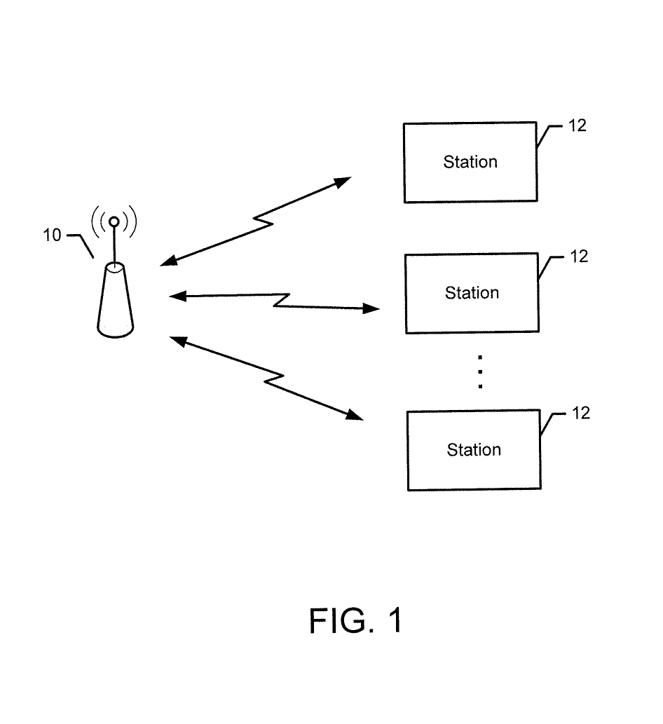

A method, apparatus and computer program product are provided in accordance with an example embodiment of the present invention in order to facilitate communications, e.g., wireless communications, such as between an access point 10 and a plurality of stations 12 as shown in FIG. 1. In particular, the method, apparatus and computer program product of an example embodiment permit the access point and the plurality of stations to remain synchronized in an instance in which the access point changes from one channel to another channel. The change in channel may occur for various reasons including a reduction in channel contention and an avoidance of interference. In this regard, the method, apparatus and computer program product of an example embodiment may facilitate synchronization between the access point and the plurality of stations in instances in which the stations sleep for extended periods of time in order to conserve energy, during which time the stations may miss the channel switch announcements provided by the access point in advance of switching from one channel to another channel.

The access point 10 and the plurality of stations 12 may communicate via a network, such as a wireless network. Although the access point and the plurality of stations may communicate in accordance with various wireless network topologies, the access point and the plurality of stations of one embodiment may communicate wirelessly in accordance with, for example, the 802.11 standard, such as the 802.11ah standard. However, the access point and the plurality of stations may communicate with one another in accordance with other network topologies and in accordance with other standards utilizing, for example, other wireless communications networks, protocols or the like.

As shown in FIG. 1, the access point 10 of one embodiment may be configured to communicate with one or more stations 12. The access point may be embodied in various different manners and may include, for example, a base station, a base station transceiver, a relay node or the like. Additionally, the stations may be embodied in a variety of different manners and may include, for example, a sensor, e.g., a weather sensor or a building environmental sensor, a dual mode cellular telephone, a smart meter, e.g., a water or gas meter, or other devices, such as household items, e.g., appliances, security systems, or heating and air conditioning systems, that are network-enabled for communication with monitoring and management systems and, as such, are configured to communicate with the access point and capable of alternately sleeping and waking in order to operate in a low power or energy efficient mode. Many of these devices may feature battery powered wireless network transmitters in order to eliminate the need for the transmitter to be coupled to a power distribution system (e.g., a wall outlet), thereby increasing the importance of operation in an energy efficient mode.

In operation, an access point 10 may communicate with one or more of the stations 12 of a BSS on a respective channel. The channels may have various bandwidths but, in one embodiment, may be relatively narrow so as to have a one MHz or two MHz bandwidth. As noted above, the stations may be configured to conserve energy by sleeping, sometimes for an extended period of time, and only occasionally awakening in order to receive information from the access point and to provide information to the access point. As such, the stations may conserve energy so as to allow for an extended period of operation in the field prior to replacement, recharging or the like.

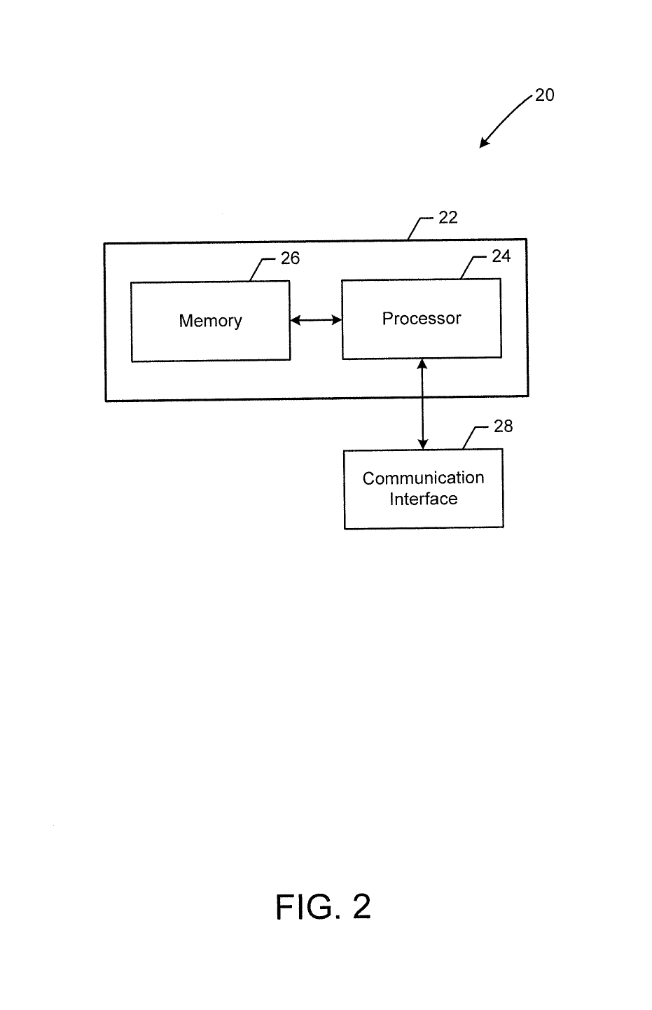

An apparatus 20 that may be embodied by or included within one or more of an access point 10 or a station 12 is shown in FIG. 2. The apparatus may include or otherwise be in communication with a processing system including, for example, processing circuitry 22 that is configurable to perform actions in accordance with some example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a communication interface 28. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal, the processing circuitry may be embodied as a portion of a mobile terminal. Alternatively, in embodiments taken in the context of an access point 14 or other network entity, the processing circuitry may be embodied as a portion of the access point or other network entity.

The communication interface 28 may include one or more interface mechanisms for enabling communication with other devices and/or networks. In some cases, the communication interface may be any means such as a device or circuitry embodied in either hardware, or a combination of hardware and software that is configured to receive and/or transmit data from/to the network and/or any other device or module in communication with the processing circuitry 22. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

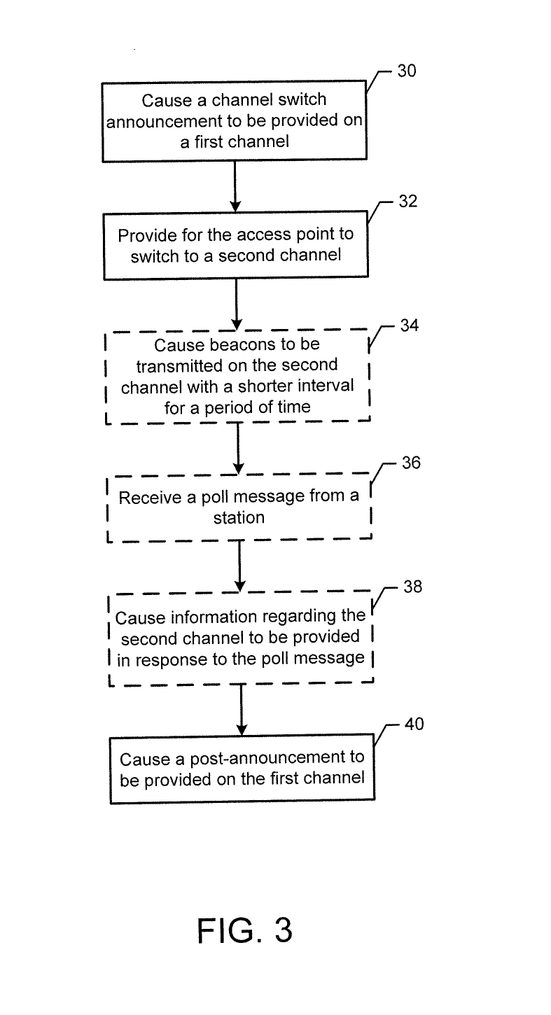

While a station 12 is sleeping, an access point 10 may switch from a first channel to a second channel so as to avoid channel contention, reduce interference or the like. Referring now to FIG. 3, the operations performed by a method, apparatus and computer program product of an example embodiment are illustrated from the perspective of an apparatus 20 that may be embodied by or otherwise associated with an access point. In this regard and as shown in operation 30 of FIG. 3 in conjunction with an impending switch from the first channel to the second channel, an apparatus embodied by the access point and, more particularly, the processing circuitry 22, the processor 24, the communications interface 28 or the like, may be configured to cause a channel switch announcement to be provided to the stations 12 on the first channel. See block 30 of FIG. 3. In this regard, the apparatus embodied by the access point may include means, such as the processing circuitry, the processor, the communication interface or the like, for causing the channel switch announcement to be provided on the first channel. The channel switch announcement may be caused to be provided a plurality of times, such as on a periodic basis.

The channel switch announcement is provided on the first channel so as to alert the stations 12 communicating with the access point 10 on the first channel that the access point is thereafter going to move from the first channel to a second channel and will subsequently communicate via the second channel. As such, the channel switch announcement may include an identification of the second channel. The second channel may be identified in various manners including any combination of a channel number and/or a channel width. The channel switch announcement may be configured in various manners, but, in one embodiment, has a predefined format with one octet providing the element identification, one octet providing the length, one octet providing the channel switch mode, one octet providing the number of the second channel, and one octet providing the channel switch count as defined, for example, in the IEEE 802.11revMB.

The apparatus 20 embodied by the access point 10 and, more particularly, the processing circuitry 22, the processor 24, the communication interface 28 or the like, may be configured to provide for switching of the access point to the second channel, such as by changing the frequency via which the access point communicates with one or more stations 12 to be within the bandwidth associated with the second channel and to no longer be within the bandwidth associated with the first channel. See block 32 of FIG. 3. As such, the apparatus embodied by the access point may include means, such as the processing circuitry, the processor, the communications interface or the like, for providing for the access point to switch to the second channel. The stations that were awake and received the channel switch announcements in advance of the switch to the second channel will generally follow the access point to the second channel and will continue communications with the access point on the second channel. However, stations that were sleeping during the transmittal of the channel switch announcements in advance of the switch to the second channel may no longer be synchronized with the access point upon awakening from sleep. In this regard, the access points that were sleeping while the access point transmitted the channel switch announcements will awake, but will no longer be in communication with the access point via the first channel since the access point has moved its communications to the second channel in the interim.

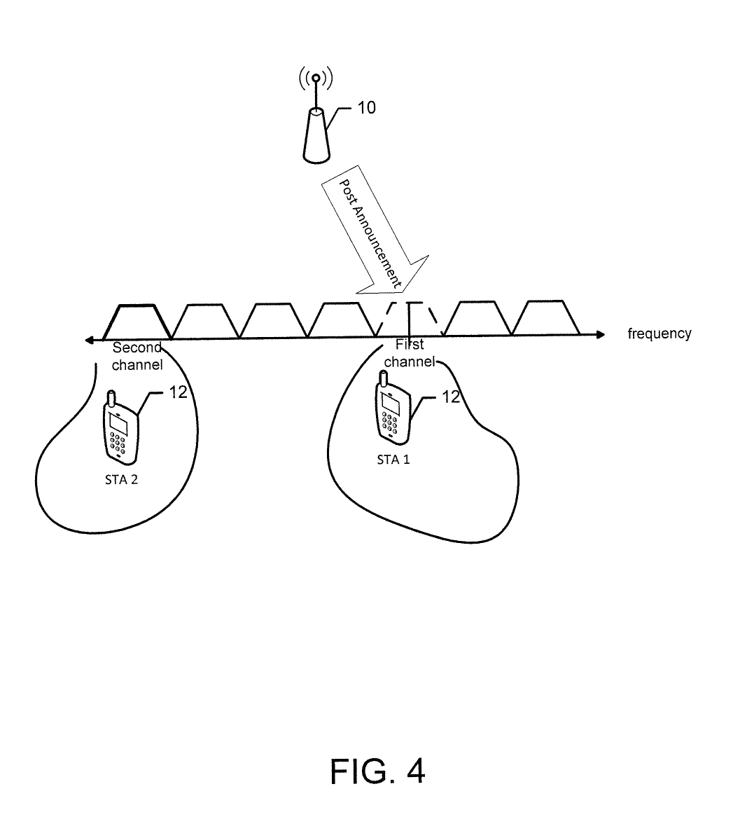

In accordance with one embodiment of the present invention, the apparatus 20 embodied by the access point 10 and, more particularly, the processing circuitry 22, the processor 24, the communication interface 28 or the like, may be configured to cause a post-announcement to be provided on the first channel indicating that the access point previously switched to the second channel. See block 40 of FIG. 3. In this regard, the post-announcement may be provided following switching of the access point to the second channel. As such, the apparatus embodied by the access point may include means, such as the processing circuitry, the processor, the communication interface or the like, for causing a post-announcement to be provided to one or more stations 12 on the first channel. As shown, for example in FIG. 4, an access point may have switched from a first channel to a second channel so as to be communicating with one or more stations via the second channel. Following the switch of the access point to second channel, the access point may transmit a post-announcement on the first channel and, in one embodiment, may transmit a plurality of post-announcements on, for example, a periodic basis on the first channel.

Upon awakening, a station 12 that was sleeping during the prior channel switch announcements that were transmitted prior to switch to the second channel and which, therefore, is unaware of the second channel to which the access point 10 has switched may receive a post-announcement that is transmitted by the access point on the first channel as a result of the stations continuing to monitor the first channel once the station has awakened. For example, the access point may broadcast a beacon, such as a short beacon, including a post-announcement information element that includes an identification of the second channel. While the post-announcement may be configured in various manners, the information element may be defined in accordance with one embodiment of the present invention that includes an element identifier to identify the information element as a post-announcement information element, a length field to identify the length of the post-announcement element and the post-announcement element itself. The post-announcement element may have a variable length that may be interpreted by the station based upon, for example, the operating class. The post-announcement element may include the number of the second channel, such as in terms of a number and/or a channel width, and may, in one embodiment, include a field indicating the number of times that the post-announcement will be repeated, the repetition period of the post-announcement or the like.

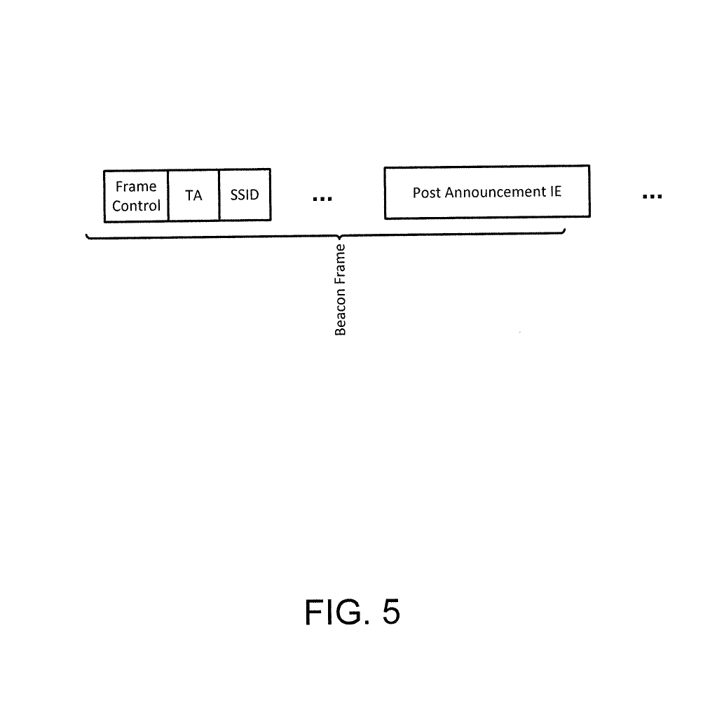

The post-announcement information element may be included within a beacon frame as shown, for example, in FIG. 5. In this regard, an example of a beacon frame that includes a post-announcement information element may include a frame control field providing an indication of the frame type. In this regard, the beacon that includes a post-announcement information element may be defined as a unique frame type or, alternatively, may be indicated to be a management frame (subtype beacon/short beacon). The beacon that includes a post-announcement information element may also include a transmitter address (TA), a service set identifier, e.g., a network name (SSID), as well as the post-announcement information element described above. In one embodiment, the post-announcement frame may only include an indication that the channel switch has occurred without any explicit indication of the second channel. The station 12 of this embodiment may then respond to the post-announcement information element by determining that the access point 10 has switched tone of the channels indicated in the reserve channel list described below.

In an embodiment in which the access point 10 includes or has access to information that defines the periods of time during which a station 12 will be sleeping and will be awake, the apparatus 20 embodied by the access point and, more particularly, the processing circuitry 22, the processor 24, the communication interface 28 or the like, may be configured to cause the post-announcement to be provided in alignment with an awake period of the station, such as by aligning the post-announcement with the target beacon transmission time (TBTT) that was used during communication on the first channel, thereby increasing the likelihood that the station will receive the post-announcement and will thereafter communicate with the access point via the second channel. However, the access point need not align the post-announcement with an awake period of the station but may, instead, transmit the post-announcement, such as on a repeated and, in one embodiment, a periodic basis to the stations monitoring the first channel.

In one embodiment, the apparatus 20 embodied by the access point 10 and more particularly, the processing circuitry 22, the processor 24, the communication interface 28 or the like, may be configured to cause beacons to be transmitted simultaneously on both the first and second channels. In this regard, the beacons transmitted via the first channel may include the post-announcement so as to alert stations 12 that were sleeping during the prior channel switch announcements that the access point has moved to the second channel. Alternatively, the apparatus embodied by the access point and more particularly, the processing circuitry, the processor, the communication interface or the like, may be configured to cause a beacon to be transmitted on the first channel that includes the post-announcement without concurrently transmitting a beacon on the second channel, that is, the access point may schedule the beacon to be transmitted on the first channel that includes the post-announcement during a contention-free period on the second channel. In another embodiment, the access point may reserve the medium on the first channel by transmitting a clear to send (CTS)-to-self message to facilitate transmission of the post-announcement on the first channel.

Once a station 12 has received a post-announcement on the first channel indicating that the access point 10 is now communicating via a second channel, the station may monitor the second channel for a beacon in order to commence communications with the access point on the second channel. In one embodiment, the apparatus 20 embodied by the access point may include means, such as the processing circuitry 22, the processor 24, the communication interface 28 or the like, for causing beacons to be transmitted on the second channel in accordance with an interval that is shorter for a predefined period of time following the switching of the access point to the second channel than the interval at which beacons are caused to be transmitted on the second channel following the predefined period of time. See block 34 of FIG. 3. Thus, for the predefined period of time following switching to the second channel, the access point may transmit beacons on the second channel with a smaller interval and, therefore, more frequently than the rate at which the access point will transmit beacons on the second channel following expiration of the predefined period of time following switching of the access point to the second channel. By broadcasting the beacons with a shorter beacon interval, the stations that have a received a post-announcement on the first channel (or the stations that missed the post-announcement but that have begun to scanning for the access point since the access point was no longer communicating on the first channel) and that are now monitoring the second channel for a beacon in order to commence communications with the access point on the second channel may receive a beacon on the second channel more quickly and therefore may be able to commence communications with the access point more quickly than if the access point transmitted the beacons on the second channel in accordance with a longer interval. The shorter beacon interval may apply to both short beacons and normal beacons and, in one embodiment, the shorter beacon interval may be realized by duplicating the same beacon frame. For stations that received the channel switch announcement and moved with the access point to the second channel, the stations may be aware of the duplication of the beacon frames and the temporarily shorter beacon interval and may disregard the duplicate beacons transmitted in accordance with the shorter beacon interval by the access point on the second channel such that the shorter beacon interval provides for quicker scanning by the stations that are monitoring the second channel following receipt of a post-announcement via the first channel without disrupting the stations that previously moved to the second channel in response to the channel switch announcements. Additionally, the access point of one embodiment may align the post-announcement transmission with the (duplicated) beacon transmissions. In this regard, the access point may concurrently transmit a post-announcement on the first channel and a beacon on the second channel.

In one embodiment, the post-announcement may be repeated by one or more stations 12 or one or more access points 10 in order to increase the likelihood that stations that were sleeping during the channel switch announcement will subsequently receive the post-announcement on the first channel. In this regard, a station, such as a station that belongs to the BSS for which the channel switch announcement was previously issued or a station that does not belong to the BSS for which the channel switch announcement was previously issued or an access point on the same channel, may receive the post-announcement and may repeat the post-announcement one or more times, such as a predefined number of times. In one embodiment, the beacon frame that is repeated by one or more stations and/or one or more access points may indicate that the post-announcement information element includes the service set identifier (SSID), such as a network name and/or a basic service set identifier (BSSID), such as a media access control (MAC) address.

In one embodiment, the apparatus 20 embodied by the access point 10 and, more particularly, the processing circuitry 22, the processor 24, the memory 26, the communication interface 28 or the like, may store the parameters that were transmitted via the channel switch announcement including, for example, identification of the second channel and the timing with which the access point is to switch to the second channel. In this embodiment, a station 12 that awakes from a period of sleep and that has not yet received a post-announcement on the first channel may send a poll message, such as a PS-Poll message, to the access point on the first channel requesting transmission by the access point of information that has previously been transmitted during the period of time in which the station was asleep. The apparatus embodied by the access point may include means, such as the processing circuitry, the processor, the communication interface or the like, for receiving the poll message. See block 36 of FIG. 3. In an instance in which the apparatus embodied by the access point and, more particularly, the processing circuitry, the processor or the like, determines that the time at which the polling message was received follows the transmission of one or more channel switch announcements, the apparatus embodied by the access point may include means, such as the processing circuitry, the processor, the communication interface or the like, for causing information regarding the second channel including an identification of the second channel and the timing with which the access point switched to the second channel, to be provided to the station in response to the poll message. See block 38 of FIG. 3. Alternatively, instead of a unicast response to the poll message, the access point may respond with an additional channel switch announcement, which is broadcast.

Based upon the response to the poll message, the station 12 may thereafter seek to communicate with the access point 10 via the second channel. Thus, while the post-announcement transmitted by an access point to a station that has recently awakened following migration of the access point to a second channel provides the station with the information necessary to synchronize with the access point by switching to the second channel, the exchange of a poll message and response following awakening of the station may provide the same or similar information to the station and may permit quicker synchronization on the second channel in some instances.

In one embodiment, an apparatus 20 embodied by an access point 10 may have selected one or more reserve channels to which the access point will move in an instance in which the current channel cannot be used anymore, such as due to channel contention, interference or the like. The apparatus 20 embodied by the access point of this embodiment and, more particularly, the processing circuitry 22, the processor 24, the communications interface 28 or the like, may cause the information regarding the one or more reserve channels to be transmitted to the stations 12, such as during the association phase or in a beacon, such as a short beacon. As such, the transition by the access point from the first channel to the second channel may be in accordance with the reserve channels with the second channel being a reserve channel. As such, in an instance in which the station awakes from a sleep period and receives a post-announcement from the access point, but has some uncertainty as to the channel to which the access point has switched (e.g., the post-announcement may indicate a set of channels where the access point will deploy the BSS or the access point may transmit only a short indication that the channel switch has occurred as noted above without providing an indication of the second channel), the station may at least initially monitor one or more of the reserve channels to determine if the station can communicate with the access point on those channels.

In regards to a reserve channel, an access point 10 may announce a single reserve channel, such as two MHz reserve channel. In an instance in which the access point is unable to establish the two MHz BSS on the channel, the reserve channel may implicitly be either the lower or the higher one MHz BSS channel within the two MHz channel that was indicated to be the reserve channel. In one embodiment, the access point may switch the two MHz BSS to a two MHz channel, that may transmit only in a one MHz BSS mode. In another embodiment, the access point may signal an offset parameter, such as N channels, which indicates the channel group to which the access point will move during a channel switch. For example, an offset parameter of M+/−N may indicate to the station 12 that the access point will have switched to a second channel with a range of channels from M−N channel to M+N channel such that the station may thereafter scan the channels from M−N to M+N to locate the second channel. Alternatively, the access point may indicate in the channel switch announcement that the current two MHz BSS will be switched to two 1 MHz BSS under the same two MHz channel. In this regard, while the channel switch may be from a first channel to a second channel that is spaced from the first channel in terms of frequency, the channel switch of one embodiment may be within the same range of frequencies, but just be a different bandwidth therein.

The listing of one or more reserve channels may be provided by the access point 10 to the stations 12 in various manners. In one embodiment, however, a reserve channel list element may be provided that includes an element identifier indicating the type of element that is provided, a length field indicating the length of the information portion and a reserve channel list element having a variable length depending upon the content which includes the channel number, mode of operation, etc. of one or more reserve channels.

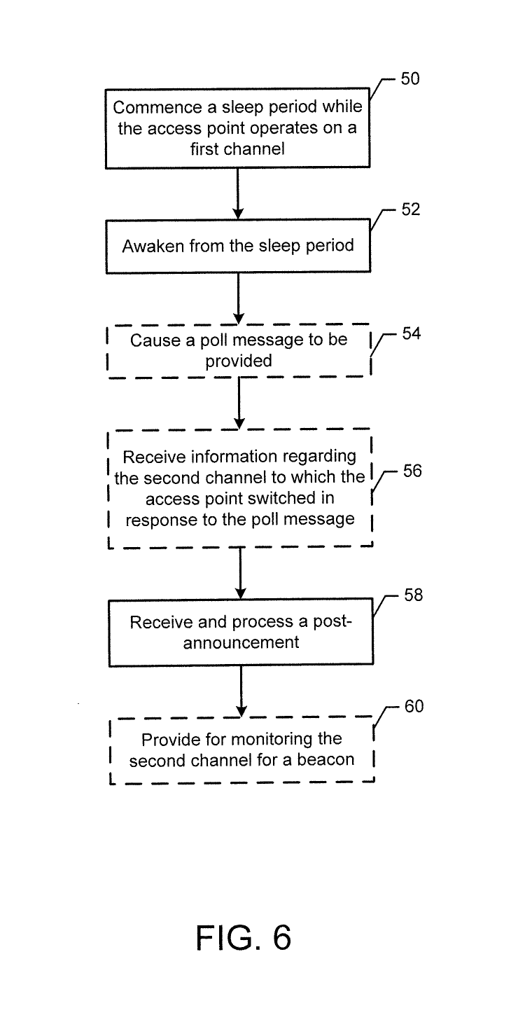

From the perspective of a station 12 that is asleep during the transmission of the channel switch announcements and which is, therefore, no longer synchronized with the access point 10 following awakening from the sleep, the apparatus 20 embodied by the station, and, more particularly, the processing circuitry 22, the processor 24, the communications interface 28 or the like, may be configured to commence the sleep period while the access point operates on the first channel. See block 50 of FIG. 6. Thus, the apparatus embodied by the station may include means, such as the processing circuitry, the processor, the communications interface or the like, for commencing the sleep period during operation of the access point on the first channel. During the sleep period, the station may operate in a low power mode of operation and, as such, may not receive the signals transmitted by the access point on the first channel.

At some point thereafter, the apparatus 20 embodied by the station 12, and, more particularly, the processing circuitry 22, the processor 24, the communications interface 28 or the like, may awaken from the sleep period. See block 52 of FIG. 6. In this regard, the apparatus embodied by the station may include means, such as the processing circuitry, the processor, the communications interface or the like, for awakening from the sleep period. As described above, the access point 10 has switched from the first channel to the second channel while the station has been asleep, such that the station is no longer synchronized with the access point upon awakening from the sleep period. However, in accordance with an example embodiment of the present invention, the apparatus embodied by the station, and, more particularly, the processing circuitry, the processor, the communication interface or the like, may be configured to receive and process a post-announcement from the access point on the first channel that indicates that the access point previously switched to the second channel. See block 58 of FIG. 6. In this regard, the post-announcement may include an indication of the second channel, such as in terms of the number of the second channel, the channel width of the second channel or the like, and, in some instances, the time at which the access point switched to the second channel. Alternatively, the post-announcement may include an indication that a channel switch has occurred without identifying the second channel (thereby implicitly indicating that the second channel is one of the reserve channels), thereby permitting the size of the post-announcement to be reduced and/or permitting a post-announcement to be transmitted even if the access point has not yet deployed the BSS but will soon do so on a reserve channel. Thus, the apparatus embodied by the station may include means, such as the processing circuitry, the processor, the communications interface or the like, for receiving and processing the post-announcement. In this regard, the apparatus embodied by the station and, more particularly, the processing circuitry, the processor, the communication interface or the like, may be configured to receive the post-announcement without first having received the channel switch announcement that indicates that the access point is to switch to the second channel.

In one embodiment, apparatus 20 embodied by the station 12 and, more particularly, the processing circuitry 22, the processor 24, the communication interface 28 or the like, may be configured to provide for monitoring of the second channel (or a reserve channel) for a beacon, such as a short beacon, in order to resynchronize with the access point 10 following receipt of the post-announcement. See block 60 of FIG. 6. Thus, the apparatus embodied by the station may include means, such as the processing circuitry, the processor, the communications interface or the like, for monitoring the second channel for a beacon following receipt of the post-announcement. After having received the beacon, the station may then be synchronized with the access point on the second channel so as to communicate therewith.

As described above, the apparatus 20 embodied by the station 12 of one embodiment may include means, such as the processing circuitry 22, the processor 24, the communications interface 28 or the like, for issuing a poll message, such as a PS-poll message, to the access point 10 in order to receive information that was otherwise to be provided to the station while the station was asleep. See block 54 of FIG. 6. In one embodiment, the poll message may be provided to the access point prior to receipt of the post-announcement. As indicated above, the poll message solicits information stored by the access point that may have been attempted to have been provided to the station while the station was asleep. The apparatus embodied by the station may include means, such as the processing circuitry, the processor, the communications interface or the like, for receiving, in response to the poll message, information from the access point which includes information regarding the second channel to which the access point has switched in an instance in which the access point switched to the second channel while the station was asleep. See block 56 of FIG. 6. The station may thereafter monitor the second channel for a beacon in order to synchronize with the access point on the second channel and to facilitate subsequent communications with the access point on the second channel prior to having received the post-announcement so as to provide for an even quicker resynchronization with the access point.

In accordance with an example embodiment of the present invention, the method, apparatus and computer program product provide for resynchronization of a station 12 with an access point 10 in an instance in which an access point has changed from a first channel to a second channel while a station was asleep. Thus, the method, apparatus and computer program product of an example embodiment facilitate ongoing wireless communications between an access point and a plurality of stations that are configured to sleep for periods of time in order to conserve energy. In this regard, the method, apparatus and computer program product of an example embodiment permit a station that awakes from a sleep period and that is no longer synchronized with the access point as a result of a transition of the access point from the first channel via which the station communicated with the access point prior to the sleep period to a second channel that is unknown to the station to quickly and efficiently identify the second channel and correspondingly to find the BSS without an extensive scan procedure, such as an active and/or passive scan procedure.

FIGS. 3 and 6 are flowcharts illustrating the operations performed by a method, apparatus and computer program product, such as apparatus 20 of FIG. 2, in accordance with one embodiment of the present invention from the perspective of an access point 10 and a station 12, respectively. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a non-transitory memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIGS. 3 and 6, when executed, convert a computer or processing circuitry into a particular machine configured to perform an example embodiment of the present invention. Accordingly, the operations of FIGS. 3 and 6 define an algorithm for configuring a computer or processing circuitry, e.g., processor, to perform an example embodiment. In some cases, a general purpose computer may be provided with an instance of the processor which performs the algorithm of FIGS. 3 and 6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included as shown, for example by the dashed lines in FIGS. 3 and 6. It should be appreciated that each of the modifications, optional additions or amplifications below may be included with the operations above either alone or in combination with any others among the features described herein. Further the operations described above and illustrated in FIGS. 3 and 6 may be performed in different orders in some embodiments than order that is illustrated.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
causing a channel switch announcement to be provided on a first channel that indicates that an access point is to switch to a second channel;
providing, with a processor, for the access point to switch to the second channel; and
following switching of the access point to the second channel, causing a post-announcement to be provided on the first channel indicating that the access point previously switched to the second channel.

2. A method according to claim 1 further comprising causing beacons to be transmitted on the second channel in accordance with an interval that is shorter for a period of time following switching of the access point to the second channel than the interval at which beacons are caused to be transmitted on the second channel following the period of time.

3. A method according to claim 1 further comprising causing beacons to be transmitted simultaneously on the first and second channels, wherein the beacon transmitted on the first channel includes the post-announcement.

4. A method according to claim 1 further comprising causing a beacon to be transmitted on the first channel that includes the post-announcement without concurrently transmitting a beacon on the second channel.

5. A method according to claim 1 further comprising:
receiving a poll message from a station; and
causing information regarding the second channel to which the access point switched to be provided in response to the poll message.

6. A method according to claim 1 wherein causing a post-announcement to be provided comprises causing the post-announcement to be provided in alignment with an awake period of a station.

7. An apparatus comprising:
at least one processor; and
at least one memory including computer program code, the at least one memory and the computer program code configured to, with the at least one processor, cause the apparatus at least to:
cause a channel switch announcement to be provided on a first channel that indicates that an access point is to switch to a second channel;
provide for the access point to switch to the second channel; and
following switching of the access point to the second channel, cause a post-announcement to be provided on the first channel indicating that the access point previously switched to the second channel.

8. An apparatus according to claim 7 wherein the at least one memory and the computer program code are further configured to, with the at least one processor, cause the apparatus to cause beacons to be transmitted on the second channel in accordance with an interval that is shorter for a period of time following switching of the access point to the second channel than the interval at which beacons are caused to be transmitted on the second channel following the period of time.

9. An apparatus according to claim 7 wherein the at least one memory and the computer program code are further configured to, with the at least one processor, cause the apparatus to:
receive a poll message from a station; and
cause information regarding the second channel to which the access point switched to be provided in response to the poll message.

10. An apparatus according to claim 7 wherein the at least one memory and the computer program code are configured to, with the at least one processor, cause the apparatus to cause a post-announcement to be provided by causing the post-announcement to be provided in alignment with an awake period of a station.

11. An apparatus according to claim 7 wherein the apparatus is embodied as an access point.

12. A method comprising:
commencing a sleep period while an access point is operating on a first channel;
awakening from the sleep period; and
receiving and processing, with a processor, a post-announcement originating with the access point on the first channel indicating that the access point previously switched to a second channel.

13. A method according to claim 12 wherein receiving the post-announcement comprises receiving the post-announcement without first having receiving a channel switch announcement indicating that the access point is to switch to the second channel.

14. A method according to claim 12 further comprising providing for monitoring of the second channel for a beacon originating with the access point following receiving and processing of the post-announcement.

15. A method according to claim 12 further comprising:
causing a poll message to be provided prior to receiving the post-announcement; and
receiving information regarding the second channel to which the access point switched in response to the poll message.

16. An apparatus comprising:
at least one processor; and
at least one memory including computer program code, the at least one memory and the computer program code configured to, with the at least one processor, cause the apparatus at least to:
commence a sleep period while an access point is operating on a first channel;
awake from the sleep period; and
receive and process a post-announcement originating with the access point on the first channel indicating that the access point previously switched to a second channel.

17. An apparatus according to claim 16 wherein the at least one memory and the computer program code are configured to, with the at least one processor, cause the apparatus to receive the post-announcement by receiving the post-announcement without first having receiving a channel switch announcement indicating that the access point is to switch to the second channel.

18. An apparatus according to claim 16 wherein the at least one memory and the computer program code are further configured to, with the at least one processor, cause the apparatus to provide for monitoring of the second channel for a beacon originating with the access point following receiving and processing of the post-announcement.

19. An apparatus according to claim 16 wherein the at least one memory and the computer program code are further configured to, with the at least one processor, cause the apparatus to cause:
cause a poll message to be provided prior to receiving the post-announcement; and
receive information regarding the second channel to which the access point switched in response to the poll message.

20. An apparatus according to claim 16 wherein the apparatus is embodied as a station.
